(19) United States
(12) Patent Application Publication
(10) Pub. No.: US 2025/0167709 A1
(43) Pub. Date: May 22, 2025

(54) METHODS AND SYSTEM BASED ON ADVANCED ENERGY SAVING APPLIED TO FREQUENCY INVERTERS OF INDUCTION MOTORS

(71) Applicant: WEG DRIVES & CONTROLS AUTOMAÇÃO LTDA, Jaraguá do Sul (BR)

(72) Inventors: Cleyson Amorim COSTA, Jaraguá do Sul (BR); Adalberto José ROSSA, Jaraguá do Sul (BR); Carlos Afonso HÜMMELGEN, Jaraguá do Sul (BR); Jacques Roberth RUTHES, Jaraguá do Sul (BR); Itamar Fernandes SOARES, Joinville (BR); Mario de Azambuja TURQUETI, Jaraguá do Sul (BR)

(21) Appl. No.: 18/833,491

(22) PCT Filed: Mar. 23, 2023
(86) PCT No.: PCT/BR2023/050099

§ 371 Date: Jul. 26, 2024

Related U.S. Application Data
(60) Provisional application No. 63/323,826, filed on Mar. 25, 2022.

(51) Int. Cl. H02P 23/26

(52) U.S. Cl. CPC H02P 23/26; H02P 2207/01

(57) ABSTRACT

A method for continuous adjustment of the power factor in an induction motor driven by a frequency inverter with escalar or vetorial control is provided, by the use of a system for advanced saving energy, having a proportional and integral controller (14), at least a selection switch (15) and a tracking module (16). The system tracks the best power factor value for a power factor reference, according to the needs of the induction motor at different operating points, and acts on the indirect regulation of the voltage applied to the stator windings of the motor induction for scalar control or acts as indirect regulation of magnetic flux for vector control, increasing in both types the efficiency of a motor due to the successively adjustments in the power factor.

### FIELD OF THE DISCLOSURE

The wider technical field of the present disclosure is related to arrangements for adjusting, eliminating or compensating reactive power in networks, the arrangements being an integral part of the load, specifically related to the measure and control of power factor, more specifically applied to save energy in frequency inverters of induction motors.

### BACKGROUND

Electric motors have been used for over a century ago, and methods for improving their energy efficiency have been extensively researched in recent years due to predictions of global energy shortages. It is estimated that more than 50% of the electricity generated in all countries is used to drive electric motors, mostly induction motors driven or not by a frequency inverter.

Due to the advantages of using a frequency inverter compared to other drive methods, its application continues to increase in replacement of other traditional induction motor drive solutions.

Considering the possibility of increasing the efficiency of induction motors driven by a frequency inverter, there is a lot of attention in recent years for the implementation of methods with the purpose of reducing losses in the induction motor, motivated by the need to reduce consumption of global energy, as well as by the reduction of carbon emission, especially in countries whose energy matrix has a large portion of the electric energy generation carried out by thermoelectric plants.

The induction motor is an electrical machine that is designed to achieve high efficiency when driven near its rated operating point or full load. However, its efficiency is significantly reduced when the operating point moves to another different operating point, for example, where an induction motor drives a mechanical load with partial torque and/or at a low rotational speed. This reduction in efficiency occurs due to the unbalance of electrical (ohmic) and magnetic (iron) losses at the different operating points.

An operating point of an induction motor is defined by a pair of values of rotational speed and mechanical torque provided on the axis of the induction motor.

Efficiency is defined as the percentage between the ratio of mechanical power delivered to a mechanical load by the shaft of the induction motor and the total electrical power provided by an electrical energy source.

Throughout the development of induction motors technology, it has always been a point of discussion between manufacturers and users the creation of a methodology for verifying efficiency. The insertion of frequency inverters expanded the discussions aiming at the possibility of variation of speed, torque, frequency, and other variables.

When trying to define and standardize the operating points and procedures for determining losses in an induction motor driven by a frequency inverter, manufacturers and users came together to elaborate the definition of efficiency classes for the induction motor driven by a frequency inverter and the assembly consisting of the frequency inverter and the induction motor.

As a proposal to harmonize and standardize procedures, the IEC 61800-9-1 standard was developed and published, which defines the drive system losses by energy efficiency classes and operating points for induction motors with nominal voltage lower than 1 kV and rated power up to 1 MW.

The standard defined efficiency classes (IE0, IE1, IE2, etc.) for induction motors driven by a frequency inverter that define the limits of relative losses at the operating point with 90% of the rotation speed and 100% of torque.

The other seven operating points, defined by a percentage of the rotation speed and a percentage of the torque, are informed in the technical documentation and their results are independent of the definition of the IE class.

To meet standardization and to increase the efficiency of the induction motor driven by a frequency inverter, several loss minimization methods have been proposed, the main ones being technically divided into i) methods based on a mathematical model and ii) methods based on optimal point search based on physical parameters.

Both methods have their advantages and disadvantages for each particular application, depending mainly on the type of mechanical load applied and the dynamic regime of torque variation.

The activation regime is evaluated by the value of the load variability rate defined by the equation:

$$ρ = k \frac{\partial {T}_{L}}{\partial t}$$

The load variability ρ depends on the load torque variability T_{L} at time t, where k is a constant; When ρ is large, the process has a fast-triggering regime and if ρ is small, the process has a slow triggering regime.

When evaluating the variability of the load ρ, care should be taken to evaluate the time interval in which the torque variation was evaluated, so that evaluation errors do not occur, being prudent to evaluate it at longer intervals of time.

If the application has a wide range of torque variation or if the induction motor is oversized and operates at a fraction of its nominal conditions, these are the characteristic conditions to apply some loss reduction technique, being the opportunities for the percentage increase of the operating efficiency higher when the torque demanded by the load is below ⅔ of the nominal torque of the induction motor.

Most of the loads driven by induction motors have a work cycle with a wide range of torque (e.g. pumps, fans, compressors, crushers, conveyor belts, etc.), allowing the application of methods to optimize efficiency at a point of operation.

However, due to the great diversification of use of induction motors in various industrial applications, it is difficult to develop a universal solution to this problem, which means that for each case, the manners to control the frequency inverter and the understanding of causes of losses, as well as ways to reduce them, must be analyzed.

As for frequency inverters, they also have differences in the type of control used to control the induction motor, which are divided into two types of speed control strategies: scalar control or vector control.

The scalar control uses the ratio between voltage and frequency imposed at the induction motor terminals, which is kept constant throughout the frequency variation range, to keep the induction motor's magnetic flux constant. This type of control is the most used due to its simplicity and the fact that in most applications it does not require high precision in the rotation speed control.

Vector control considers the instantaneous electrical variables, referenced to the flux coupled to the rotor of the induction motor, and its equations are based on the spatial dynamics of the mathematical model of the induction motor, which is seen as a vector and controlled as a direct current motor, with separately controlled torque and magnetic flux. This type of control allows fast responses and a high level of precision in controlling rotational speed and mechanical torque.

For the frequency inverter with scalar control, the most used method to reduce losses is to modify the voltage/frequency ratio, reducing and regulating the voltage imposed on the induction motor. For the frequency inverter with vector control, the most common methods are the reduction and regulation of magnetic flux.

An immediate effect directly linked to the low efficiency of an induction motor is a low power factor. On the other hand, the point of greatest efficiency occurs when the magnetic flux is regulated according to the need of the actuated mechanical load.

In an induction motor working at partial load and the frequency inverter with scalar control, decreasing the voltage applied to the induction motor terminals can increase the power factor, however its slip increases with the reduction of the voltage at the terminals of the induction motor, indicating that the voltage reduction proportionality may not be the same as the power factor increase.

Similarly, in an induction motor working at partial load and the frequency inverter with vector control, when reducing the magnetic flux, the power factor does not vary proportionally, due to the slip variation to maintain the induction motor rotation speed.

With this consideration, just reducing the voltage of the terminals or the magnetic flux of the induction motor does not serve the purpose of increasing efficiency and only when the reduction in this voltage is greater than that of the slip and with the increase in the power factor, induction motor efficiency can be improved.

Additionally, an induction motor driving a mechanical load has different optimized power factor values, and by adjusting the power factor to this optimized power factor value, they cause it to indirectly vary the characteristics of the current and voltage applied to the induction motor, reducing electrical and magnetic losses.

This evaluation led to the development of control techniques to keep the power factor constant by varying the triggering angle of thyristors, which despite its apparent simplicity, regulate the power factor by electronic means following a power factor reference. But this technique does not show good results due to the constructive differences and powers of the induction motors, which has different values of optimized power factor and, moreover, for different nominal operating points it has different values of optimized power factor.

From the identification of such a problem, a system that tracks the best value for a power factor reference, according to the needs of the induction motor at different operating points will have its efficiency increased.

In view of that, the present invention presents a method for reducing the total losses of the induction motor driven by a frequency inverter, by including a usable advanced energy saving for both scalar and vector control modes of a frequency inverter.

The advanced energy saving performs the tracking of the best power factor reference value to be followed by scalar control or vector control of a frequency inverter and acts on the indirect regulation of the voltage applied to the stator windings of the motor induction for scalar control or acts as indirect regulation of magnetic flux for vector control.

For scalar control, the voltage versus frequency ratio is regulated to obtain the minimum power consumption point with the highest power factor, allowing the voltage versus frequency ratio to assume values smaller or larger than the nominal voltage frequency ratio.

For vector control, the magnetic flux is regulated to obtain the minimum power consumption point with the highest power factor, allowing the magnetic flux to assume values smaller or larger than the nominal magnetic flux.

There are some prior art documents that use power factor regulation to reduce losses, however, there are still some deficiencies in this power factor control.

For example, the document U.S. Pat. No. 4,052,648, expired in 1994, presents a control system for the regulation of the power factor that, when placed in circuit with the input of energy from an induction motor, effects a reduction in the energy normally supplied to the motor when operated in a condition where the line voltage is greater than normal and/or the motor load is less than a rated load by modifying the current waveform to follow a reference displacement between the voltage waveform and current waveform. This increases the efficiency but is just used for fixed speed.

The document U.S. Pat. No. 4,291,264, expired in 1999, discloses a control system which uses means to measure the power factor and means to control an inverter drive ac induction motor to follow a constant desired power factor, regardless of load variation to improve the efficiency, but the user needs to select by manually adjusting for the desired power factor.

The document U.S. Pat. No. 5,010,287, expired in 1998, discloses a variable frequency drive to drive the induction motor, including a power factor detecting section to detect the power factor phase angle between the motor current and the inverter voltage output. Some judge means are used to compare the detected power factor phase angle with a predetermined reference angle, in order to provide a control output response with a predeterminate relationship with the frequency for improving motor efficiency, by using the storage/designation of one of voltage per frequency curves, selecting at least one curve to control the voltage per frequency relation in order to improve efficiency, the method needs the input related to previous knowledge of a plurality of voltage per frequency curves together to the different induction motor.

The document U.S. Pat. No. 5,204,606, expired in 2010, shows the means to detect the power factor, being that, once detected, said power factor is compared with an ideal value of power factor, to obtain an error amount that is determined in accordance with the motor load. An optimum power factor circuit to convert this load variation parameter into an optimum value of power factor is provided, as a relationship between the working power and the compensation. However, this compensation is an approximation, not an optimization, and the power factor is just increased and decreased with the increase and decrease of the working power in a proportional manner.

The document U.S. Pat. No. 5,241,256, expired in 2010, uses the same basic idea from U.S. Pat. No. 5,204,606, but instead of using an approximation, it uses a set of curves, in a set of tables stored memory, between motor load and optimal power factor and a family of curves related to the power factor compensation and motor supply voltage with different frequencies applied to the induction motor. One drawback of this solution is: if the characteristics of the induction motor change, a new set of tables must be used and stored in memory.

In the document U.S. Pat. No. 8,339,093, the control system inputs a plurality of modified voltage-frequency commands to the ac motor drive and determines the real-time value of the motor parameter corresponding to each of the plurality of modified voltage frequency commands and identifies an optimal value of the motor parameter based on the real-time values of the motor parameter for open-loop motor drive. Thus, this method disturbs the system with different V/Hz ratios and measure parameters to use in open-loop motor drives but cannot be used for vector control or closed-loop applications.

### SUMMARY

The present invention provides a method for continuous tracking of the power factor in an induction motor driven by a frequency inverter with escalar or vetorial control, by the use of a system for advanced saving energy, comprising a proportional and integral controller (14), at least a selection switch (15) and a tracking module (16). The system tracks the best power factor reference, according to the needs of the induction motor at different operating points and acts on the indirect regulation of the voltage applied to the stator windings of the motor induction for scalar control or acts as indirect regulation of magnetic flux for vector control, increasing in both types of the efficiency of a motor due to the successively adjustments in the power factor reference. The method also can be used in closed-loop regulation for both scalar or vector control and for different mechanical load characteristics either can be linear, quadratic, constant, or another one, since that the operation point is a stable operating point (speed and torque).

### BRIEF DESCRIPTION OF THE DRAWINGS

In the drawings:

FIG. 1 shows the block diagram of the scalar control of the frequency inverter with the advanced energy saving (4);

FIG. 2 presents the block diagram of the frequency inverter vector control with the advanced energy saving (4);

FIG. 3 presents the block diagram of the advanced energy saving (4);

FIG. 4 presents the flowchart of the ways to store the variable reference power factor FPᵥₐᵣ* to use for optimization tools or frequency inverter replacement;

FIG. 5 shows the dynamic behavior of the adjusted power factor reference FP* over time and of an X variable to be minimized in relation to the power factor variable reference FPᵥₐᵣ;

FIG. 6 shows the results applying the method, showing the variation of voltage, current, losses and temperature increase in different operation points of speed and torque.

FIG. 7 shows the standardized operation points used to evaluate the method.

FIG. 8 shows the application of the advanced energy saving with an induction motor operating at ¼ of the rated speed with scalar control (V/f);

FIG. 9 shows the application of the advanced energy saving with an induction motor operating at ⅔ of the rated speed with scalar control (V/f);

FIG. 10 shows the application of the advanced energy saving with an induction motor operating at nominal speed with scalar control (V/f);

FIG. 11 shows the convergence of the tracking module from the variable reference power factor FPᵥₐᵣ to scalar control (V/f);

FIG. 12 shows the application of the advanced energy saving with an induction motor operating at ¼ of the nominal speed with vector control;

FIG. 13 shows the application of the advanced energy saving with an induction motor operating at ⅔ of the rated speed with vector control;

FIG. 14 shows the application of the advanced energy saving with an induction motor operating at nominal speed with vector control;

### DETAILED DESCRIPTION

In the following description, for the purpose of explanation, numerous specific details are set forth to provide a thorough understanding of the present disclosure. It will be apparent, however, that embodiments may be practiced without these specific details. Embodiments are disclosed in sections according to the following outline:

The present invention presents a method for reducing the total losses of the induction motor driven by a frequency inverter by including an implementable advanced energy saving either one scalar or vector control modes.

The advanced energy saving performs the tracking of the best power factor reference value to be followed by scalar control or vector control of the frequency inverter and performs indirect regulation of the voltage applied to the stator windings for scalar control or indirect regulation of magnetic flux for vector control.

This invention provides a method for continuous adjustment of the power factor in an induction motor driven by a frequency inverter, comprising the steps of:
a) to select a power factor variable reference FPᵥₐᵣ* by a selection switch (15) for tracking at an operation point;
b) to increase or decrease with steps of ΔFP the current power factor FP of the induction motor (7) during a time interval Δt using the tracking module (16) defining an adjusted power factor reference signal FP*;
c) to input the adjusted power factor reference signal FP* in the proportional and integral controller (14);
d) to provide a control sign dfₚ* to be added to the current power factor FP using the proportional and integral controller (14);
e) to repeat for countless times the steps (a) to (d) while the frequency inverter is driving the induction motor.

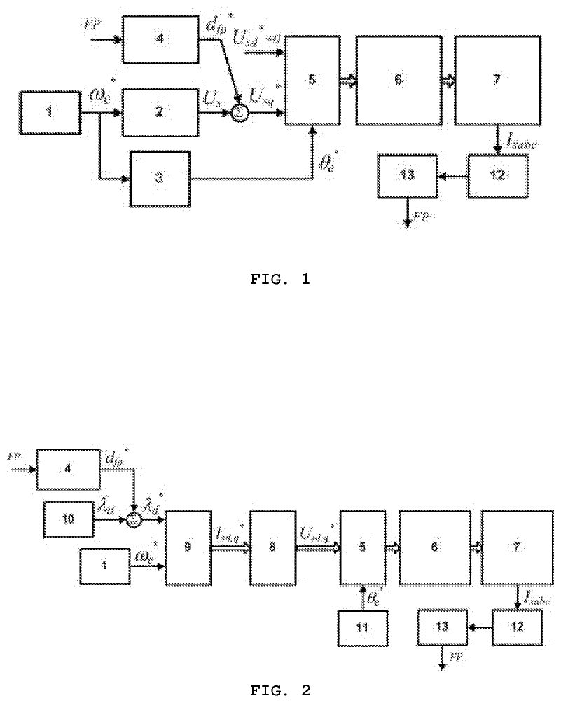

FIG. 1 presents the block diagram of the scalar control of a frequency inverter with the inclusion of the advanced energy saving (4) proposed in this invention.

The said method for continuous adjustment of the power factor in an induction motor driven by a frequency inverter when used with scalar control, further comprises the steps:
d.1) provide a module of advanced energy saving, wherein the voltage reference Uₛ, represented by the value of the voltage vector initially imposed on the induction motor, is added with the control sign dfₚ*, outputting the adjusted quadrature voltage reference U_{sd}*;
d. 2) to provide an integrator which defines, from the angular speed reference ωₑ*, the synchronous angle θₑ* to the structure of the scalar control;
d. 3) to provide an activation sequence of the power stage switches of the induction motor from the calculation of an inverse Park transform, having as parameters the synchronous angle θₑ*, the calculated adjusted quadrature voltage reference U_{sq}* and a null direct voltage reference U_{sd}*;
d. 4) to estimate the current power factor FP constantly from the current signal provided by a current sensor and the U_{sq}* adjusted quadrature voltage reference;
d. 5) to fed back the current power factor signal FP to the block, wherein the output varies the amplitude of the voltage imposed on the induction motor stator (7);
d. 6) to track and determine the operation point with the highest power factor and the lowest voltage amplitude imposed on the induction motor stator, from the disturbance caused by the variation in the amplitude of the voltage;
d. 7) to regulate the voltage versus frequency ratio obtaining the lowest power consumption point with the highest power factor;
d. 8) to allow the voltage versus frequency ratio to assume values smaller or larger than the nominal voltage frequency ratio.

The speed reference signal (1) provides the frequency inverter with an acceleration ramp with predefined acceleration and deceleration limits for driving the induction motor (7). The rotational speed at which the induction motor (7)) will be accelerated is defined by the signal ωₑ* given by (1).

The voltage reference signal (2) provides the frequency inverter which voltage is to be imposed on the induction motor (7) along with the speed acceleration ramp required for scalar control.

The voltage reference provided by the frequency inverter is defined by variable Uₛ, provided by the voltage reference signal (2) and represents the vector value of the voltage imposed on the induction motor (7).

The integrator (3) provides, from the signal ωₑ*, the synchronous angle θₑ* for the scalar control structure, used as an input signal for the Inverse Park Transform block (5).

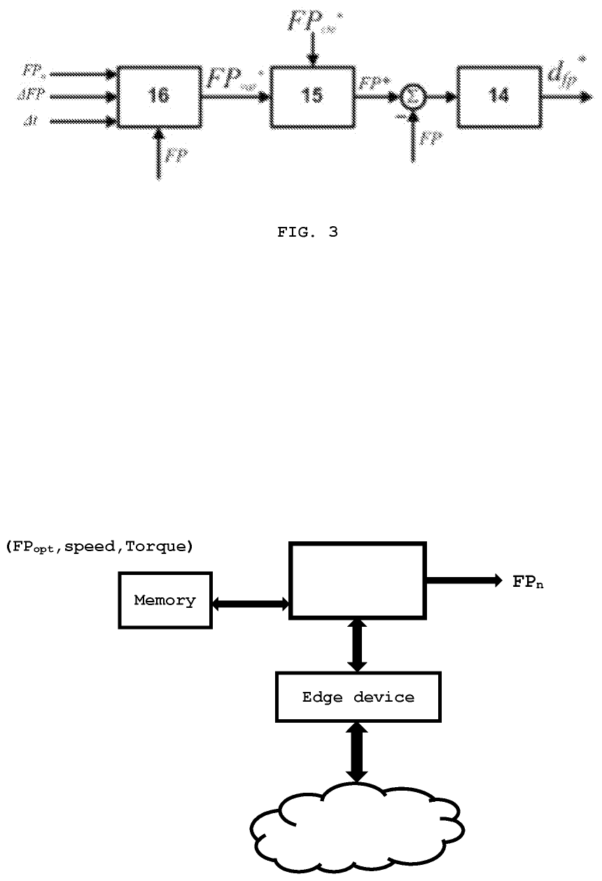

The advanced energy saving (4) represents the control function that is applied in the frequency inverter to reduce the energy consumption of the induction motor (7) and said advanced energy saving (4) is detailed in FIG. 3 and FIG. 4.

The control signal d_{fp}* is summed with the Uₛ signal to generate the output of the reference voltage signal U_{sq}* and represents the voltage vector value imposed on the induction motor (7) adjusted by the advanced energy saving (4).

The control signal d_{fp}* represents the control action of the advanced energy saving (4) and the signal U_{sd}* represents a null voltage vector.

With the signals U_{sd}*, U_{sq}* and θₑ*, the Inverse Park Transform (5) is obtained, which provides the activation sequence of the power stage switches (6) for the activation of the induction motor (7).

The current sensor (12) provides a signal that represents the current passing through the induction motor stator windings (7) which together with the U_{sq}* reference voltage is estimated the current power factor FP (13).

The current power factor signal FP represents the power factor signal which is one of the advanced energy saving inputs (4).

The scalar control mode works as follows: When applying a speed reference (1), block (2) generates a voltage reference Uₛ proportional to the speed reference signal ωₑ*.

Block (5) applying the Inverse Park Transform generates a three-phase voltage signal for the power stage (6) that feeds the induction motor (7).

The frequency inverter constantly acquires the currents from the stator windings of the induction motor (7) to estimate the current power factor signal FP of the induction motor (7).

The current power factor signal FP is fed back to the block (4), whose output varies the amplitude of the voltage imposed on the induction motor stator (7).

This variation in voltage amplitude causes disturbance in the system to track and determine the point of greatest efficiency, in this case, with the highest power factor and the smallest voltage amplitude imposed on the induction motor stator (7).

For scalar control, the voltage versus frequency ratio is regulated to obtain the minimum power consumption point with the highest power factor, allowing the voltage versus frequency ratio to assume values smaller or larger than the nominal voltage frequency ratio.

FIG. 2 presents the vector control block diagram of a frequency inverter with the inclusion of the advanced energy saving (4) proposed in this invention.

The addition of the advanced energy saving (4) for frequency inverter with vector control does not imply any changes in its operation compared to that presented for scalar control.

The said method for continuous adjustment of the power factor in an induction motor driven by a frequency inverter when used with vector control, further comprises the steps:
a) to provide a module of advanced energy saving, wherein the magnetic flux reference λd, represented by the value of the magnetic flux initially imposed on the induction motor, is added with the control sign dfₚ*, outputting the adjusted magnetic flux signal λ_{d}*;
b) to provide an integrator (1) which defines the angular speed reference ωₑ* and a block state observer (11) which defines the synchronous angle θₑ*;
c) to provide an activation sequence of the power stage switches of the induction motor from the calculation of an inverse Park transform, having as parameters the synchronous angle θₑ*, the calculated adjusted quadrature voltage reference U_{sq}* and a null direct voltage reference U_{sd}*;
d) to estimate the current power factor FP constantly from the current signal provided by a current sensor and the U_{sq}* adjusted quadrature voltage reference;
e) to feedback the power factor signal FP to the block (4), wherein the output varies the amplitude of the magnetic flux imposed on the induction motor stator (7);
f) to track and determine the operation point with the highest power factor and the lowest magnetic flux amplitude imposed on the induction motor stator, from the disturbance caused by the variation in the amplitude of the magnetic flux;
g) to regulate the magnetic flux obtaining the lowest power consumption point with the highest power factor.

The speed reference (1) generates the signal ωₑ* which is used as one of the inputs to the speed and flux controller (9), the other input receives the adjusted magnetic flux signal λ_{d}* obtained from the sum of the flux reference signal λ_{d} (10) and of the control signal d_{fp}* which represents the control action of the advanced energy saving (4).

With the flux reference signals λ_{d} (10) and d_{fp}*, the speed and flux controller (9) generate the current control signals I_{sd,q} which are used as input to the current controller (8), which provides the signal U_{sd,q} as an input to the Inverse Park Transform block (5).

The synchronous angle signal θₑ* is generated by the state observer block (11) and is used as input to the Park transform inversion block (5).

A state observer is used to estimate state variables based on measures of output variables and control variables regardless of whether these variables are accessible, since the observability condition is satisfied.

In the same way as in scalar control, with the signals U_{sd}*, U_{sq}* and θₑ*, the Inverse Park Transform (5) is obtained, which provides the activation sequence of the switches from the power stage (6) to the induction motor drive (7).

The current sensor (12) provides a signal representing the current passing through the induction motor stator windings (7), with which, together with the voltage with the signals U_{sd}*, U_{sq}*, the current power factor FP (13) is estimated, which is one of the advanced energy saving inputs (4);

The determination of the inverse of the Park transform (5), of the power stage (6), of the induction motor (7), of the current sensor reading (12) and of the power factor estimator (13) have the same structure and function for scalar control, so the descriptions previously made are also valid for the vector control.

The vector control mode works as follows: When a three-phase switched voltage signal is applied by the frequency inverter to fed an induction motor, according to the vector control structure in FIG. 2, the power factor signal is fed back into block (4).

The control signal d_{fp}* from the block (4) summing with the reference magnetic flux λ_{d} (10) in order to change the amplitude of the adjusted magnetic flux λ_{d}* imposed on the air gap of the induction motor (7).

This change allows the system to be disturbed and thus the advanced energy saving (4) tracking the point of greatest efficiency, as explained for scalar control, in this case, with the highest power factor and the smallest amplitude of the adjusted magnetic flux λ_{d}* imposed on the air gap of the induction motor (7).

For vector control, the adjusted magnetic flux λ_{d}* is regulated to obtain the minimum power consumption point with the highest power factor, allowing the magnetic flux to assume values smaller or larger than the nominal magnetic flux.

FIG. 3 shows the block diagram of the internal structure of the system of advanced energy saving (4), object of the present invention, in which the signal source for the regulation of the adjusted power factor reference FP*, selected among a fixed reference of power factor FP_{cte}* or a variable reference of power factor FPᵥₐᵣ* to be set at an operating point.

The presente invention provides a system for advanced energy saving comprising:
a proportional and integral controller (14);
at least a selection switch (15);
a tracking module (16);
wherein a power factor variable reference FPᵥₐᵣ* is initially selected by a selection switch (15), making the tracking module (16) increasing or decreasing the power factor variable reference FPᵥₐᵣ*with steps of ΔFP, at each time interval Δt, to establish an adjusted power factor reference FP* signal to be added to the current power factor FP of the induction motor (7) which is currently inputed in the proportional and integral controller (14) to provide a control sign (dfₚ*).

A select switch (15) selects the adjusted power factor reference FP* signal source, which can be selected between fixed power factor reference FP_{cte}* or power factor variable reference FPᵥₐᵣ* values according to a user-configured parameter.

The fixed power factor reference FP_{cte}* represents a constant power factor reference, which can be used to drive the induction motor (7), selectable by a parameter.

In this condition where the adjusted power factor reference FP* will be a constant value, that is FP_{cte}*=FP*, the frequency inverter, depending on the used type of control scalar or vector, regulates the drive parameters for regulation of the current power factor FP of the induction motor (7) at the fixed power factor reference FP_{cte}*.

A lower value than required for FP_{cte} may demand from the frequency inverter a high voltage value to be supplied to the induction motor stator (7) which may not be supplied, once the DC link may not have enough voltage amplitude to fed that high voltage value, causing pulsating torque and instability in the regulation of rotating speed.

A value greater than required for FP_{cte}, on the contrary, may demand from the frequency inverter a reduced voltage value to be supplied to the induction motor stator (7) which may be insufficient to maintain the rotor movement and cause it to stall.

In view of these usual limitations and undesirable effects, this invention proposes to vary the adjusted power factor reference FP* to a value optimized by tracking module (16) increasing or decreasing the power factor variable reference FPᵥₐᵣ* with steps of ΔFP, at each time interval Δt, to establish an adjusted power factor reference signal FP*, to avoid those instable operating point of the induction motor (7) due to unoptimized power factor reference.

When selecting by the selection switch (15), the variable power factor reference FPᵥₐᵣ* to the adjusted power factor reference FP*, where the variable power factor reference FPᵥₐᵣ* represents the variable power factor reference to be adjusted by the tracking algorithm according to an operating point of the induction motor (7).

When the induction motor (7) reaches a stable operating point, the tracking algorithm, implemented in the tracking module (16), starts the increasing or decreasing of variable power factor reference FPᵥₐᵣ* to the adjusted power factor reference FP* and evaluation of the current power factor FP of the induction motor (7) and the stability conditions of the control to find the optimized value of the variable power factor reference FPᵥₐᵣ* for an operating point.

It is considered that the induction motor (7) reached a stable operating point when the rotation speed of the rotor of the induction motor (7) reached the reference speed ωₑ*.

The initial value used to start tracking the variable reference power factor FPᵥₐᵣ* is the nominal power factor value of the induction motor FPₙ usually available on the induction motor nameplate (7).

Different initial values of the nominal power factor FPₙ can be stored in memory and the values already optimized power factor FPₒₚₜₘ for an induction motor operating point (7) can be stored too, aiming to decrease the convergence time, as shown in FIG. 4.

Each optimized value of current power factor FP shall be stamped in memory with optimized power factor FPₒₚₜₘ related to an operation point identified by its speed and torque;

Storage can be local, in a non-volatile memory, or it can be stored remotely by some communication medium for later access by the frequency inverter.

This functionality allows that in an environment of applications related to industry 4.0, such as the use of machine learning tools and/or artificial intelligence, these optimizations can be used for the self-configuration of the frequency inverter when in a similar application or in the replacement in case of failure, without any loss of the learning realized on the optimization of the power factor with the induction motor and operating point.

The tracking algorithm automatically looks for the optimized value of the power factor variable reference FPᵥₐᵣ*, varying FPᵥₐᵣ* with steps of ΔFP, increasing or decreasing depending on the evaluation of the current power factor FP of the induction motor (7) during the time interval Δt.

The value ΔFP is setup calculated as a function of the nominal power factor FPₙ value of the induction motor (7) and kept constant throughout the tracking process.

The value of ΔFP is much smaller than the nominal power factor FPₙ value of the induction motor (7) to avoid pulsing rotor torque during the tracking process.

The value of time interval Δt is calculated at the start of the tracking module (16), from the induction motor nameplate data that is provided by the user during the drive and induction motor configuration process.

The value of time interval Δt is much greater than the switching period of the power stage (6) of the frequency inverter and is proportional to the rotor time constant of the induction motor and kept constant throughout the tracking process.

The motor rotor time constant is estimated from the rated slip frequency and the rated power of the induction motor.

The proportional and integral controller (14), whose input is the difference of the adjusted power factor reference signal FP* and the estimated signal of the current power factor FP, is used for the regulation of the FP* and FP variables providing the d_{fp}* variable.

The variable d_{fp}* represents the control action of the proportional and integral controller (14) used to regulate the current power factor FP, which acts on the stator voltage and/or magnetic flux of the induction motor (7) to search the lowest power consumption point for an operating point.

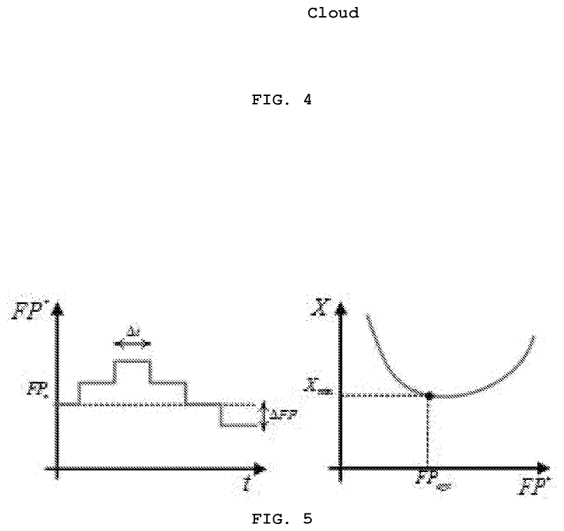

FIG. 5(a) presents the behavior of the power factor variable reference FPᵥₐᵣ* over time and FIG. 5(b) represents the minimization curve of the variable to be minimized represented by the value Xₘᵢₙ.

The variable to be minimized can be selected by the user from the parameter setting to perform the minimization of a variable to be minimized.

The variable to be minimized X can represent, for example, the current signal passing through the stator windings Iₛ or active power Pₑ consumed by the induction motor (7).

In the search condition for the best power factor variable reference FPᵥₐᵣ*, the algorithm automatically searches for the best power factor variable reference FPᵥₐᵣ* with the smallest value of variable to be minimized.

By selecting variable to be minimized, the variable to be minimized is read continuously, and the algorithm is updated at each time interval Δt.

If the result is negative, that is, the variable to be minimized is smaller than the previous sample, checks whether the variable to be minimized has been incremented or decremented previously, and, if this condition is satisfied, it decrements at a step of ΔFP the variable power factor reference FPᵥₐᵣ* or if this condition is not satisfied, it increases at a step of ΔFP the variable power factor reference FPᵥₐᵣ*.

If the result is positive, that is, the variable to be minimized is greater than the previous sample, checks whether the variable has been incremented or decremented previously, if this condition is satisfied, it increments in a step of ΔFP the power factor variable reference FPᵥₐᵣ* or if this condition is not satisfied, decrements by a step of ΔFP the power factor variable reference FPᵥₐᵣ*.

This process remains indefinitely while the frequency inverter is driving the induction motor (7), whether using scalar control or vector control.

The power factor variable reference signal FPᵥₐᵣ* will continuously apply a variation of a step of ΔFP at each time interval Δt in order to find and maintain the minimum point of the chosen X variable.

The effect of applying the adjusted power factor reference FP* tracking module is not exclusively to increase the current FP power factor, but rather to seek a current FP power factor value so that there is an increase in the efficiency of the induction motor.

Some data were obtained, when applying the advanced energy saving (4), object of the present invention, in a frequency inverter with scalar control and performing tests at relevant operating points for verification.

FIG. 6 shows the standardized operation points, related to speed and torque, used to evaluate the method. The operation points 2, 3, and 8, are at the 100% of the relative torque e different values of the relative speed: 50%, 25% and 10%, respectively. A decreasing in the torque for 50% is evaluated at the points for 4 and 5, with 90% and 50% of the speed. The points 6 and 7, are evaluated in the conditions of 25% of the torque and 50% and 25% of the speed.

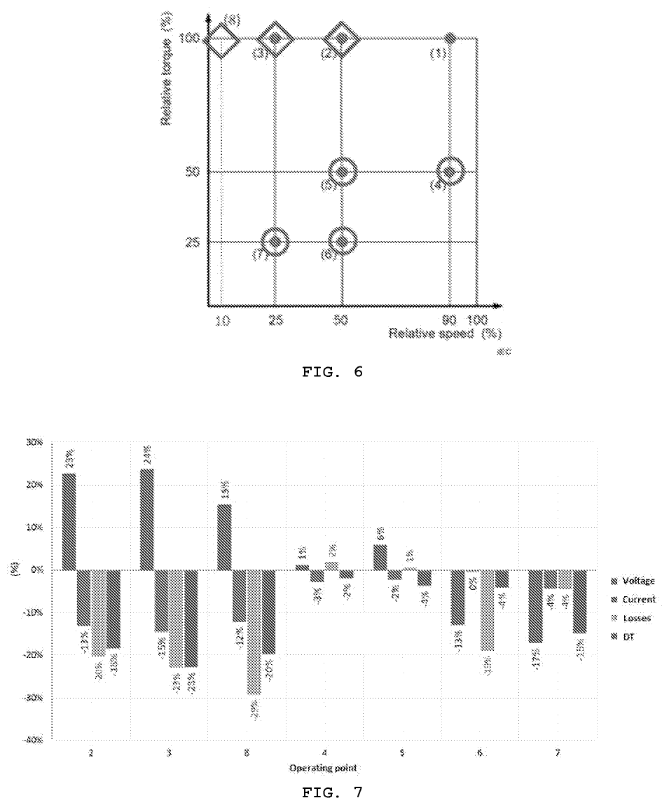

FIG. 7 shows the results during some tests applied in an induction motor using a frequency inverter with the proposed method and compared to the same without the method in percentage. With 100% of the relative torque, at points 2, 3, and 8, the voltage increases and current, losses and temperature variation decrease and obviously the efficiency of the induction motor decrease. With 50% of the relative torque, at points 4 and 5, a small increase in the voltage and losses is verified, with the reduction in the current and temperature variation. With 25% of the relative torque, the voltage, current, losses and temperature variation also decrease.

The results show that using the method, instead to increase or decrease the voltage applied, it is possible to increase the efficiency.

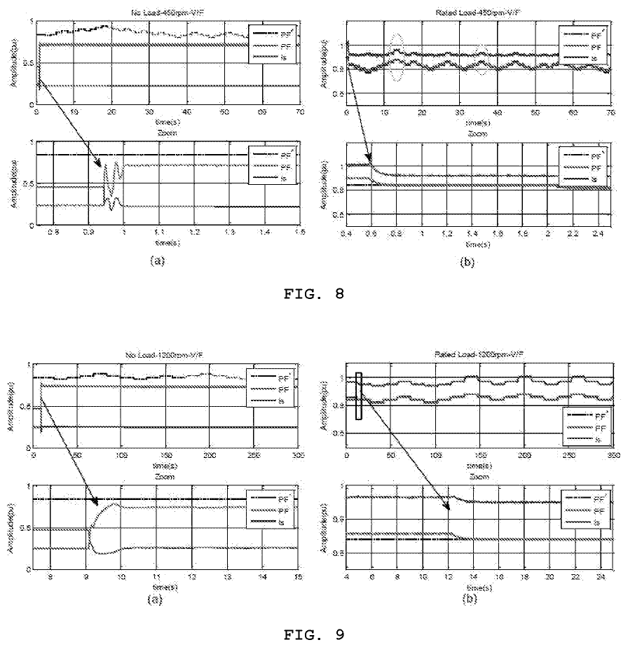

FIGS. 8, 9 and 10 show the control variables with scalar control of the stator winding current Iₛ, of the current power factor FP, and of the adjusted power factor reference FP* for ¼ of the rated speed, ⅔ of the rated speed and rated speed, respectively, for an induction motor driven by a frequency inverter operating with no-load torque in FIGS. 8(a), 9(a) and 10(a) and with rated torque in FIGS. 8(b), 9(b) and 10(b).

In the tests with the induction motor operating points with no-load torque, shown in FIGS. 8(a), 9(a) and 10(a), when applying the advanced energy saving (4), the control action signal d_{fp}* starts acting by setting quadrature voltage reference U_{sq}*, which decreases stator current Iₛ and increases current power factor FP to follow set power factor reference FP*.

The current power factor FP initially does not reach the set power factor reference value FP* due to the application of the voltage reduction limitation imposed on the induction motor stator windings, to prevent stalling from occurring of the rotor due to insufficient torque.

Even with the limitation of voltage reduction Vₛ imposed on the stator windings, it is possible to increase the current power factor FP and decrease the current of the stator windings Iₛ in this case, despite the adjusted power factor reference FP* it has not yet approached the proper FP current power factor for the operating point in the no-load induction motor test time period, the tracking module will trend this value.

The value of this adjusted power factor reference FP* at this operating point or other operating points can be stored in a non-volatile memory or stored and made available for remote access (cloud) by a communication means present in the frequency inverter, to decrease the convergence time of the FP* adjusted power factor reference with FP.

In the tests with nominal torque shown in FIGS. 8(b), 9(b) and 10(b), the current power factor FP follows the adjusted power factor reference FP*, since the proximity to the rated power factor FPₙ, set in the drive's initial setup, is permanently set to the best set power factor reference FP* for the operating point.

When applying the advanced energy saving for tracking the best adjusted power factor reference FP*, the actual power factor FP has an increment, and the stator winding current Iₛ having a small reduction due to the point of operation is close to the rated operating point at which the induction motor is designed.

The adjusted power factor reference FP*, in the context of FIGS. 8, 9 and 10, is adjusted to reduce the active electrical power vector Pₑ, this effect being achieved by increasing the voltage in the stator windings Vₛ, which for its realization, it is necessary that the voltage on the DC V_{bdc} of the frequency inverter has a voltage level sufficient to enable the voltage increase in the stator windings Vₛ.

At these operating points, the possibilities for increasing efficiency are limited to the adjustment of the adjusted power factor reference value FP* and the nominal power factor FPₙ of the induction motor used at the beginning of the process, but with faster convergence.

During the performance of the advanced energy saving (4), in addition to monitoring the current power factor FP, the current of the stator windings Iₛ is also monitored, and when an increase or decrease in the current Iₛ is noticed, in the next step of adjusted power factor reference update FP*, a decrease or increase in steps of ΔFP will occur in the FP adjusted power factor reference FP*.

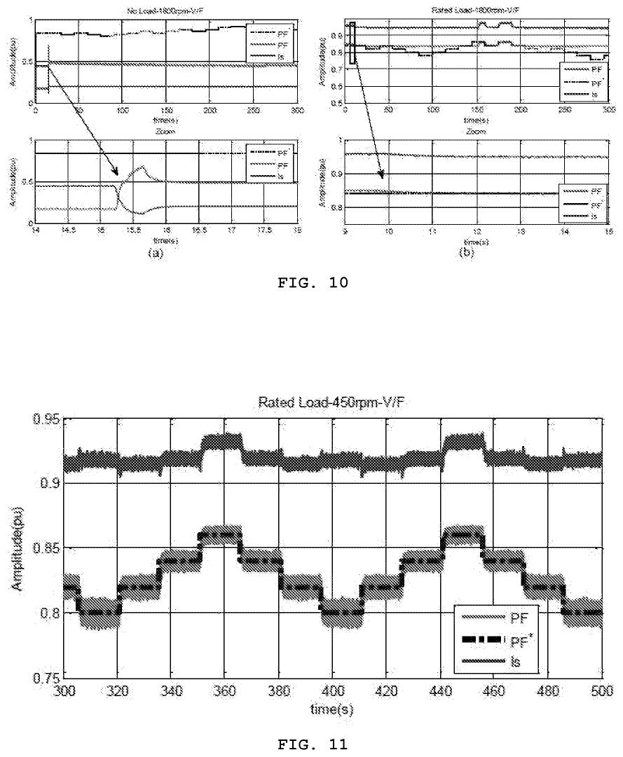

This statement is shown in FIG. 11, which presents the results of the convergence of the advanced energy saving in tracking the best adjusted power factor reference FP* to the smallest current vector Iₛ of the induction motor with nominal load and at ¼ of the nominal rotation speed.

Likewise, the advanced energy saving, object of the invention, was applied in a frequency inverter with vectorial control, performing the tests at operating points relevant to the verification.

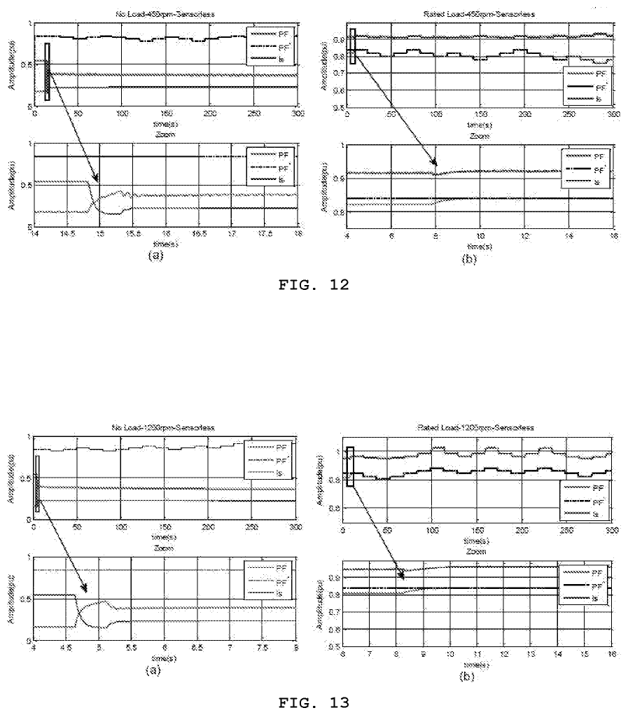

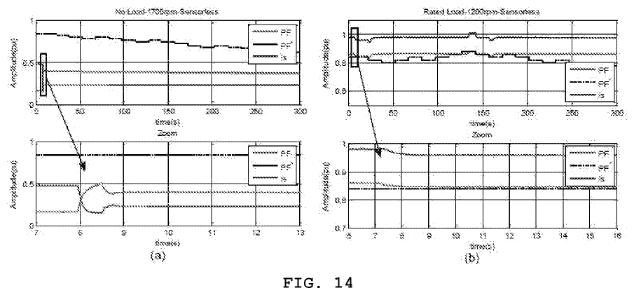

FIGS. 12, 13, and 14 show the control variables with vetorial control of the stator winding current Iₛ, the current power factor FP, and the adjusted power factor reference FP* for ¼ of the rated speed, ⅔ of the rated speed and the rated speed, respectively, for an induction motor driven by a frequency inverter operating with no load in FIGS. 12(a), 13(a) and 14(a) and with rated torque in FIGS. 12(b), 13(b) and 14(b).

In the tests with the induction motor operating points with no-load torque, shown in FIGS. 12(a), 13(a) and 14(a), when applying the advanced energy saving, the action signal control switch d_{fp}* starts acting by adjusting the magnetic flux reference λ_{d}*, which decreases the stator current Iₛ and increases the power factor FP to follow the adjusted power factor reference FP*.

The actual power factor FP, as in scalar control, initially does not reach the set power factor setpoint FP* due to the application of the magnetic flux reduction limitation imposed on the induction motor, to prevent the rotor stall due to insufficient torque.

Even with the limitation of the magnetic flux reduction imposed on the induction motor, it is possible to increase the current power factor FP and decrease the current of the stator windings Iₛ, in this case, despite the adjusted power factor reference FP* it has not yet approached the proper current power factor FP for the operating point in the no-load induction motor test time period, the tracking module will tend to this value.

The value of this adjusted power factor reference FP* at this operating point or other operating points can be stored in a memory or stored and made available for remote access by a communication means present in the frequency inverter, to decrease the convergence time of adjusted power factor reference FP* with actual power factor FP.

In the tests with nominal torque shown in FIGS. 12(b), 13(b) and 14(b), the adjusted power factor reference FP* follows the current power factor FP, since the proximity to the rated power factor FPₙ, set at initial drive setup and being permanently set to the best set power factor reference FP* for the operating point.

When applying the advanced energy saving for tracking the best adjusted power factor reference FP*, the actual power factor FP was incremented, and the stator winding current Iₛ had a small reduction due to the set point located close to the rated operating point at which the induction motor was designed.

The adjusted power factor reference FP*, in the context of FIGS. 12, 13 and 14, is adjusted to reduce the active power vector Pₑ, this effect being achieved by electrical increasing the magnetic flux reference λ_{d}* by the action of control d_{fp}* of the advanced energy saving by increasing the voltage in the stator windings Vₛ, which for its realization, it is necessary that the voltage in the V_{bdc} direct current busbar is sufficient to enable the increase of the magnetic flux imposed on the induction motor by the frequency inverter.

As with scalar control, at these operating points, the possibilities for increasing efficiency are limited to setting the adjusted power factor reference value FP* compared to the nominal power factor FPₙ of the induction motor used at the start of the process, however the fastest convergence.

The dynamic behavior of the reference power factor search function, whose operating points are the same as those used for scalar control, was no change in the structure of the reference power factor search function when applied in vector control.

1. A method for continuous adjustment of the power factor FP in an induction motor driven by a frequency inverter, comprising the steps of:
a) selecting a power factor variable reference FPᵥₐᵣ* by a selection switch (15) for tracking at an operation point;
b) increasing or decreasing with steps of ΔFP the current power factor FP of the induction motor (7) during a time interval Δt using the tracking module (16) defining an adjusted power factor reference signal FP*;
c) inputting the adjusted power factor reference signal FP* in the proportional and integral controller (14);
d) providing a control signal dfₚ*) to be added to the current power factor FP using the proportional and integral controller (14);
e) repeating for countless times the steps (a) to (d) while the frequency inverter is driving the induction motor.

2. The method of claim 1, wherein the induction motor control can be scalar type or vector type.

3. The method of claim 1, wherein for an induction motor control with scalar control, it further comprises the steps of:
d.1) providing a module of advanced energy saving, wherein the voltage reference Uₛ, represented by the value of the voltage vector initially imposed on the induction motor, is added with the control sign dfₚ*, outputting the adjusted quadrature voltage reference U_{sq}*;
d.2) providing an integrator which defines, from the angular speed reference ωₑ*, the synchronous angle θₑ* to the structure of the scalar control;
d.3) providing an activation sequence of the power stage switches of the induction motor from the calculation of an inverse Park transform, having as parameters the synchronous angle θₑ*, the calculated adjusted quadrature voltage reference U_{sq}* and a null direct voltage reference U_{sd}*;
d.4) estimating the current power factor FP constantly from the current signal provided by a current sensor and the U_{sq}* adjusted quadrature voltage reference;
d.5) feeding back the current power factor signal FP to the block, wherein the output varies the amplitude of the voltage imposed on the induction motor stator (7);
d.6) tracking and determining the operation point with the highest power factor and the lowest voltage amplitude imposed on the induction motor stator, from the disturbance caused by the variation in the amplitude of the voltage;
d.7) regulating the voltage versus frequency ratio obtaining the lowest power consumption point with the highest power factor.
d.8) allowing the voltage versus frequency ratio to assume values smaller or larger than the nominal voltage frequency ratio.

4. The method of claim 1, wherein for an induction motor control with vector control, it further comprises the steps of:
d.1) providing a module of advanced energy saving, wherein the magnetic flux reference λ_{d}, represented by the value of the magnetic flux initially imposed on the induction motor, is added with the control sign dfₚ*, outputting the adjusted magnetic flux signal λ_{d}*;
d.2) providing an integrator which defines the angular speed reference ωₑ* and a block state observer which defines the synchronous angle θₑ*;
d.3) providing an activation sequence of the power stage switches of the induction motor from the calculation of an inverse Park transform, having as parameters the synchronous angle θₑ*, the calculated adjusted quadrature voltage reference U_{sq}* and a null direct voltage reference U_{sd}*;
d.4) estimating the current power factor FP constantly from the current signal provided by a current sensor and the U_{sq}* adjusted quadrature voltage reference;
d.5) feeding back the power factor signal FP to the block, wherein the output varies the amplitude of the magnetic flux imposed on the induction motor stator (7);
d.6) tracking and determining the operation point with the highest power factor and the lowest magnetic flux amplitude imposed on the induction motor stator, from the disturbance caused by the variation in the amplitude of the magnetic flux;
d.7) regulating the magnetic flux obtaining the lowest power consumption point with the highest power factor.
d.8) allowing the magnetic flux to assume values smaller or larger than the nominal voltage frequency ratio.

5. The method of claim 1, wherein the adjusted power factor reference signal FP* is a value selected between FP_{cte}* or FPᵥₐᵣ* values according to a user-configured parameter.

6. The method of claim 1, wherein the power factor variable reference FPᵥₐᵣ* is the variable power factor reference to be adjusted by the tracking module (16) according to an operating point of the induction motor (7).

7. The method of claim 1, wherein the induction motor reaches an stable operation point when the rotation speed of the rotor of the induction motor (7) reached the reference speed ωₑ*.

8. The method of claim 1, wherein the initial value used to start tracking the variable reference power factor FPᵥₐᵣ* is the nominal power factor value of the induction motor FPₙ.

9. The method of claim 8, wherein initial values of the optimized power factor FPₒₚₜₘ and the values already optimized for an induction motor can be stored in a local non-volatile memory or in a remote memory.

10. The method of claim 8, wherein said initial values of the nominal power factor FPₙ and the values already optimized power factor FPₒₚₜₘ for an induction motor can auto-configure the frequency inverter based on machine learning and/or artificial intelligence.

11. The method of claim 1, wherein one step of ΔFP should be much smaller than the nominal power factor FPₙ value of the induction motor (7).

12. The method of claim 1, wherein time interval Δt should be much greater than the switching period of the power stage (6) of the frequency inverter

13. The method of claim 1, wherein time interval Δt should be proportional to the rotor time constant of the induction motor.

14. The method of claim 1, wherein time interval Δt should be kept constant throughout the tracking process.

15. The method of claim 1, wherein the control sign dfₚ* acts on the stator voltage and/or magnetic flux of the induction motor (7) searching the lowest power consumption point for an operating point.

16. The method of claim 1, wherein the variable to be minimized can be selected by the user from the parameter setting of the block (17).

17. The method of claim 16, wherein said variable is preferably the current signal passing through the stator windings Iₛ or active power Pₑ consumed by the induction motor (7).

18. The method of claim 1, wherein automatically searches for the best power factor variable reference FPᵥₐᵣ* are conducted with the smallest value of the variable to be minimized.

19. The method of claim 1, wherein the variable to be minimized is read continuously, and the algorithm is updated at each time interval Δt for comparison in the comparator (18).

20. The method of claim 1, wherein when the result is negative, it is checked whether the variable was incremented or decremented previously, and, if this condition is satisfied, it decrements steps of ΔFP the variable power factor reference FPᵥₐᵣ* or if this condition is not satisfied, it increases steps of ΔFP the variable power factor reference FPᵥₐᵣ*.

21. The method of claim 1, wherein when the result is positive, checks whether the variable has been incremented or decremented previously, if this condition is satisfied, it increments steps of ΔFP the power factor variable reference FPᵥₐᵣ* or if this condition is not satisfied, decrements steps of ΔFP the power factor variable reference FPᵥₐᵣ*.

22. A system for advanced energy saving comprising:
a proportional and integral controller (14), at least a selection switch (15) and a tracking module (16), all embedded in the frequency inverter;
wherein a power factor variable reference FPᵥₐᵣ* is initially selected by a selection switch (15), making the tracking module (16) increasing or decreasing the current power factor FP of the induction motor (7) during a time interval Δt, to establish an adjusted power factor reference signal FP* which is currently inputed in the proportional and integral controller (14) to provide a control sign dfₚ* to be added to the current power factor FP.
